(19) United States
(12) Patent Application Publication
(10) Pub. No.: US 2025/0297846 A1
(43) Pub. Date: Sep. 25, 2025

(54) HUMAN INTERACTION ELEMENT WITH MEASUREMENT FUNCTION FOR COORDINATE MEASURING MACHINE

(71) Applicant: HEXAGON TECHNOLOGY CENTER GMBH, Heerbrugg (CH)

(72) Inventors: Rainer SUN, Lauterach (AT); Jochen SCHEJA, Hohenems (AT)

(73) Assignee: HEXAGON TECHNOLOGY CENTER GMBH, Heerbrugg (CH)

(21) Appl. No.: 18/907,352

(22) Filed: Oct. 4, 2024

(30) Foreign Application Priority Data
Oct. 5, 2023 (EP) 23201938.0

(51) Int. Cl. G01B 5/012

(52) U.S. Cl. CPC G01B 5/012

(57) ABSTRACT

An articulated coordinate measuring machine comprising, a base, a set of articulated elements, a probe and an operator action sensor mounted on a hand-controlled member. The operator action sensor is configured to derive operator action data, regarding a force or a torque exerted or a displacement caused by an operator action on a hand-controlled member of the articulated arm coordinate measuring machine.

### FIELD

The disclosure relates to an operator action sensor for a substantially manually driven articulated arm coordinate measuring machine (AA-CMM), the CMM with the operator action sensor and the operation of said CMM. The CMM comprises a probe for approaching an object point, and a set of members connecting the probe to a base. The probe is moved at least partially manually by an operator exerting a force or torque on a hand-controlled member of the set of members.

### BACKGROUND

A CMM is a machine configured to measure 3D coordinates of certain points, in particular the whole surface topography, of a workpiece. CMMs are important in various industries, e.g. production measurement, quality control, or reverse engineering. They are utilized, e.g., to determine deviations of the geometry of manufactured products from design models, in particular to determine whether the deviations are within the manufacturing tolerance. Another application of a CMM gaining more prominence is the reverse engineering of an object, where no design model exists, but an operator provides a guidance of the probe.

Portable measurement arms offer a flexible, time and cost-efficient solution for such measurement tasks. Portable measurement arms comprise a base connecting the machine to a typically inert support structure, a set of articulated elements, a set of internal sensors providing data regarding the state of said elements, a probe interface a configured to accommodate a probe, typically in an exchangeable manner, and one or more probe. The probe is configured to interact with the workpiece in tactile and/or in non-contact manner and (relative) coordinate data regarding an object point on the workpiece is derived based on the state of the articulated elements and a data provided by a probe.

Many designs are at least theoretically feasible for the types and arrangement of the articulated elements of portable measurement arms. However, practical considerations, e.g., the need for ultra-high accuracy, low weight, large accessible volume, lead to a preferred embodiment, in which the arm comprises a series of hinges and elongated cylinders comprising parts allowing rotation about their axes. Most of the above-mentioned elements are non-motorized, i.e., the probe head is manually guided and a decisive part of the driving force for the movement of the articulated elements is provided by the muscle power of the operator.

To achieve high mobility and good accessibility of the workpieces such CMM-s are under-defined systems, i.e., the same pose of the probe can be realized by different relative poses of the element. Such CMMs are typically operated by a “two-handed grip”, wherein the operator fixes the pose of the probe with one hand, and holds one of the intermediate members to provide a suitable pose of said member, e.g., the second cylinder or the second hinge. Said intermediate member will be referred to in the following as the “hand-controlled member”. Alternatively, the operator might guide the probe without directly providing the pose for any intermediate members, this guidance will be referred to as “one-handed grip”. In the latter case the probe interface or a suitable alternative component plays the role of the “hand-controlled member”.

Since the torque or force caused by the operator grip on the hand-controlled member is a mandatory feature of operating such instruments, it is desirable to determine the magnitude and impact of the direct operator action on the AACMM.

Furthermore, some contemporary embodiments of the portable measurement arms comprise servo units to aid the operator in guiding the probe head or the portable measurement arm is realized as fully motorized arm. Due to the design of the articulated elements, providing commands for the servo units or motors is however non-intuitive and does not correspond to the typical workflow.

### SUMMARY

In view of the above circumstances, one object of the present disclosure is to improve the handling of manually guided AACMMs, in particular to provide an easy-to-handle command element for the AACMM.

A second objective of the present disclosure is to improve the measurement accuracy of AACMMs.

The disclosure relates to an operator action sensor for an AACMM. The operator action sensor is configured to be mounted on a hand-controlled member of an AACMM. The hand-controlled member is configured to be held by an operator of the AACMM. The operator action sensor is configured to detect an operator action, comprising exertion of a force and/or a torque by the operator to the operator action sensor for providing a desired pose of the hand-controlled member. The operator action sensor is configured to transfer a force and/or torque at least partly to the hand-controlled member. The operator action sensor is configured to generate operator action sensor data and provide it to the AACMM. The operator action sensor data comprises at least two-degree-of-freedom data regarding (a) the force and/or the torque exerted by the operator, and/or (b) a displacement caused by the operator action. Displacement in the sense comprises rigid body translation, rotation, straining and shearing.

The operator action sensor data, in the sense, represent an effect of direct mechanical contact between the AACMM and the operator. Direct mechanical contact might be a support/hold of the machine, but can equally represent the guidance of the probe, i.e., dynamic action. The inventive sensor or system at least derive data regarding the effect, i.e., bending, shearing, straining, on the components of AACMM. Said operator action sensor data might also be used for providing commands for the AACMM. E.g., the AACMM might provide an assessment regarding a planned operator action and provide the commands to improve the accuracy, reach etc. of the AACMM for a subsequent measurement.

In some embodiments, the operator action sensor comprises a first and a second sensor element. The first and second sensor elements are configured to be mounted to the hand-controlled member with a defined geometric spacing and held independently by the operator. In other words, the operator action sensor might support holding the hand-controlled member at different positions or orientations. This feature is especially useful, when the operator prefers to perform a measurement sequence with a grip change, e.g., directly controlling the pose of the hand-controlled member during a coarse repositioning and performing the actual measurement by grabbing the probe. In some specific embodiments, the operator action sensor data comprises data regarding a bending of the hand-controlled member. Alternatively or additionally, the operator action sensor might comprise a third sensor element mounted to a further member and/or to the probe.

In some embodiments, the operator action sensor comprises a feedback element, in particular a feedback element with light emitting diodes (LED), configured to provide feedback regarding an operational status of the operator action sensor and/or the CMM. Feedback in the sense might represent simple data, e.g., an error state detected, standby or sensor/servo active. Such simple feedback might be realized by LED lights, or a light band configured to provide three different colors. Feedback might also represent more complex data and the operator action sensor might comprise a display unit to display the data. The operator action sensor might be configured to provide haptic or acoustic feedback.

In some embodiments, the operator action sensor comprises a command input element configured to receive operator command input data and to provide it to the CMM. The operator command input data might cause the activation or deactivation of functionalities or modes, e.g., a precision or repositioning mode, or an assistance or safety functionality. In some specific embodiments, at least one command input element is a hardware button or switch and the operator command input data correspond to an interaction or a state of the button or switch. Alternatively or additionally, at least one command input element might be a touch sensitive surface and the operator command input data correspond to a touch gesture, in particular a multi-touch gesture. The CMM might be configured to interpret the operator command input data based on a context sensitive menu.

In some embodiments, the operator action sensor comprises (a) an outer surface configured to be held by the operator, (b) an inner surface configured to interact with the hand-controlled member, in particular to transfer a part of the force or torque exerted by the operator, (c) an internal volume comprising a sensing element configured to provide the operator action sensor data, and (d) a thermal isolation region configured to provide a thermal isolation between the inner and the outer surfaces. In some specific embodiments, the operator action sensor comprises a bearing configured to provide a rotatability of the outer surface with respect to the internal volume such that the operator action sensor data is provided independently of the rotation state of the outer surface.

The present disclosure also relates to an AACMM. The AACMM comprises a probe for approaching an object point, a set of members connecting the probe to a base, and a set of internal sensors. The members comprise links and joints.

The probe is moved at least partially manually by an operator exerting a force or torque on a hand-controlled member of the set of members. Moving at least partially manually in the sense comprises full manual control, with substantially all the driving force being provided by the muscle power of the operator. Motorized or predominantly servo-assisted operation, in which the operator gives guidance commands by gesture means and by touching the hand-controlled member, also constitutes a case of moving the probe interface at least partly manually. In other words, the operator guides the probe not in a remote controlled fashion, e.g. by a joystick or buttons arranged on a control element physically distinct from the articulated members of the AACMM. The probe is configured to measure probing data corresponding to an interaction between the probe and the object point.

Each sensor of the set of internal sensors is (i) associated with at least one of the members or the base, and (ii) configured to provide actual link data regarding a measured length and/or bending of the respective link, and/or actual joint data regarding a measured pose change provided by the respective joint or the base. The CMM is configured (a) to provide a pose of the probe based on the actual link and actual joint data, and (b) to provide coordinate data of the object point based on the probing data and the pose of the probe.

The CMM further comprises an inventive operator action sensor mounted at a hand-controlled member. The operator action sensor is configured to generate operator action sensor data and provide it to the CMM. The hand-controlled member can be any one articulated members. Moreover, the disclosure is in no way limited to the application of a single sensor element and a single hand-controlled member. A plurality of sensor elements might be utilized sequentially or in a parallel manner. From here on, unless otherwise provided, only embodiments with a single sensor element are discussed in detail. The specific features of AACMMs having a plurality of sensor elements shall be applied accordingly.

In some embodiments, the CMM comprises a pose determination functionality for determining the pose of the probe. The pose determination functionality comprises (i) accessing arrangement data comprising data regarding an arrangement of the members and kinematic constraints between the members, (ii) providing component geometry data for each of the links comprising (a) the actual link data, or (b) link model data regarding a calculated length and/or bending of the respective link based on the arrangement data, the actual link data, the actual joint data and the operator action sensor data, (iii) providing component geometry data for each of the joints comprising (a) the actual joint data, and/or (b) joint model data regarding a calculated pose change provided by the respective joint based on the arrangement data, the actual link data, the actual joint data, and the operator action sensor data; and (iv) providing the pose of the probe based on the arrangement data and the component geometry data. It is clear that the utilization of numerals and letters does not represent a sequence of performing the said actions, but rather a listing of actions to be carried out in a sensible order. Variations in realizing the embodiments are within the sense.

Embodiments in which the component geometry data is derived by modelling the AACMM with respect to the arrangement data are advantageous for high precision measurement. Especially when the modelling is performed based on sensor data and respecting the kinematic and dynamic behavior of the various components. Nevertheless, one or more components might be represented by nominal geometry data or nominal joint data, in particular wherein said component is idling during the measurement or its contribution to the measurement inaccuracies is negligible as compared to other components.

In some embodiments, the component geometry data comprise model and/or actual data for a plurality of members from the set of members, in particular each member. In some specific embodiments, the actual and/or model data comprises data regarding effects of gravity on the set of members. In some specific embodiments, the model data is derived based on actual data associated for at least one member, in particular for each member. The disclosure can be beneficially used for modelling the AACMM. I.e., processing the operator action sensor data to derive the effect of operator actions for each of the member allows a more precise modelling of the AACMM. Nevertheless, the disclosure is also applicable without a modelling of the AACMM.

In some embodiments, the AACMM comprises a counterweight unit associated with a first joint and configured to provide a servo-torque. The AACMM comprises an assistance functionality. The assistance functionality comprises (a) deriving for the first joint a resultant torque resulting from the force or torque exerted by the operator by guiding the hand-controlled member, and (b) providing a servo-torque acting in a direction corresponding to the resultant torque. In some specific embodiments, the CMM regulates the servo-torque such that the force and/or torque exerted by the operator, or the displacement caused by the operator is reduced, in particular approaches zero. In other words, the servo-torque reduces the magnitude of the force/torque the operator needs to exert. Alternatively or additionally, the CMM might derive the resultant torque on the basis of the arrangement data, the actual joint data and the actual link data.

In some specific embodiments, the first joint connects a base to a first link. The counterweight unit comprises (i) a passive component comprising a counterbalance and/or a spring, in particular a coil spring arranged along an axis of the first link, (ii) an active component comprising a motor, and (iii) a mechanism configured to transfer torques provided by the active and passive components to the first joint. The torque provided by the passive component is constant or corresponds to a gravity related torque acting on the first joint. The torque provided by the active component is responsive to the operator action sensor data. Such design enables a better responsiveness by the active component. The torque provided by the passive component is adjustable in some embodiments.

In some specific embodiments, the AACMM comprises a further counterweight unit associated with a second joint connecting the first link to the second link. The further counterweight unit is similar to or a simplified version of the counterweight unit, in particular it might comprise only a non-adjustable passive component. Alternatively or additionally, the base might be motorized and a base servo-torque is provided analogously to the servo-torque.

In some embodiments, the AACMM is configured to provide the servo-torque in dependence of (i) a pose and type of the probe, and/or (ii) a linear and/or angular velocity of the probe, and/or (iii) an orientation of the second link and/or, (iv) a pose of the second joint, and/or (v) a previous operator action, e.g. operator command input data. The servo-torque might be regulated based on a plurality of such parameters. E.g., a distance, which might be considered typical repositioning distance for a tactile sensor can equally be a measurement distance for a non-contact sensor.

In some specific embodiments, the AACMM is configured to operate in a precision mode and in a repositioning mode. The precision mode and the repositioning mode are activated automatically based on the pose or operational status of the probe, automatically based on operator action data, or manually by receiving respective operator command input data. In some specific embodiments, the AACMM is configured to recognize the mounted probe, e.g., whether a tactile or non-contact probe is utilized, and update the activation regime for the precision mode and repositioning mode with respect to the recognized probe.

In the precision mode (i) a velocity of at least one member is limited to a velocity range corresponding to a precision mode, (ii) an orientation of at least one member is limited to an orientation range corresponding to the precision mode, (iii) the responsiveness of the active component to the operator action sensor data is increased to a value corresponding to the precision mode. In particular the precision mode is configured to support a slow, precise positioning of the probe with respect to certain features of the workpiece in the proximity of the workpiece. The probe is guided in precision mode with reduced physical effort, in particular substantially without resistance.

In the repositioning mode (i) velocities above the velocity limit of the precision mode are enabled, and (ii) the responsiveness of the active component to the operator action sensor data is decreased to a value corresponding to the repositioning mode. In particular the repositioning mode is configured to support coarse movement of the AACMM, e.g. bringing the AACMM into a parking position during the exchange of the workpiece.

In some embodiments, the hand-controlled member is the link kinematically nearest to the probe. In some specific embodiments, the operator action sensor is configured to provide at least three degrees of freedom operator action sensor data. These embodiments are beneficial as the operator action sensor itself is arranged on a movable member, i.e., its attitude with respect to the workpiece varies during a measurement. In other words, operator action sensors configured to provide operator action sensor data irrespectively of the orientation of the sensor are advantageous. It is beneficial if the operator action sensor is configured for isotropic response or at least calibrated to compensate an attitude dependent sensitivity. Despite the above benefits at least the core aspects might be realized with simpler operator action sensors.

The disclosure also relates to a method for determining a force or a torque exerted by an operator guiding a hand-controlled member of an AACMM in an external reference frame. The AACMM comprises a probe for approaching the object point, and a set of members connecting the probe to a base. The members comprise links and joints. The probe is moved at least partially manually by an operator guiding a hand-controlled member of the set of members.

The method comprises (i) accessing arrangement data comprising data regarding an arrangement of the members and kinematic constraints between the members, (ii) accessing component geometry data for each of the links, comprising (a) actual link data regarding a measured length and/or bending of the respective link, and/or, (b) link model data regarding a calculated length and/or bending of the respective link; and (iii) accessing component geometry for each of the joints comprising (a) actual joint data regarding a measured pose change provided by the respective joint, and/or, (b) joint model data regarding a calculated pose change provided by the respective joint, (iv) providing the pose of the hand-controlled member based on the arrangement data and the component geometry data, (v) measuring operator action sensor data, wherein the operator action sensor data comprises data regarding (a) the force and/or torque exerted by the operator on the hand-controlled member, and/or, (b) a displacement, i.e. strain or shearing, caused by the operator action, (vi) deriving the force or torque exerted by the operator guiding the hand-controlled member in the external reference frame based on the pose of the hand-controlled member and the operator action sensor data.

In some embodiments, the method further comprises (i) providing an overload feedback based on the operator action sensor data, and/or (ii) deriving intended operator movement data based on the operator action sensor data. Alternatively or additionally, the operator action sensor data might be processed in providing the component geometry data regarding the hand-controlled member.

In some embodiment, the method further comprises (i) determining, based on the operator action sensor data, whether the operator acts on the hand-controlled member, and (ii) causing a motionless parking state of the CMM, if the operator is not acting on the hand-controlled member, in particular bringing the probe to a pre-defined parking pose. Force/displacement sensors are inherently capable of providing touch/grip data, and this data can be advantageously utilized to improve the safety and user comfort of the AACMM instrument. A motionless parking state might be provided by passive friction or lock elements, by specific mechanical constructs, or active, motorized control. Two types of parking state might be provided. A short-term stable pose is advantageous for cases wherein the operator has to interrupt the measurement to perform a different task. For such interruptions, a stabilization of the probe close to its actual pose could be provided, allowing easy continuation of the measurement task. Contrary to that, it is advantageous to provide a long term, safe parking pose between the measurement tasks. I.e., pose that reduces the risk of damage to the articulated members, the probe interface and the probe, while allowing ergonomic replacement of the probe. In some specific embodiments, the hand-controlled member is the link that is kinematically the nearest to the probe.

In some embodiments the method comprises an assistance functionality. The assistance functionality comprises (i) deriving a resultant torque for a first joint resulting from the operator guiding the hand-controlled member, and (ii) applying a servo-torque to the first joint acting in a direction corresponding to the resultant torque. In some specific embodiments, the servo-torque is adjusted to constrain (i) a movement of a second joint in a plane perpendicular to the gravity vector, wherein the second joint connects a second link to the first link, or (ii) an orientation of the second link in plane perpendicular to the gravity vector, or (iii) all of the members to a vertical plane.

In some embodiments, the method comprises a safety functionality. The safety functionality comprises (i) providing a forbidden zone, in particular wherein an operator sets an upper and/or a lower safety level of a first joint, (ii) providing an assessment on an approach of the first joint, to the forbidden zone, and (iii) preventing the first joint to enter the forbidden zone.

The AACMM might comprise imaging or scanning sensors to automatically collect information regarding the environment and provide the forbidden zones based on the collected information. Alternatively or additionally, the forbidden zone might be provided on the basis of a workpiece data. One aspect relates to protect the AACMM and/or the workpiece from machine crashes potentially cause high material damage.

### BRIEF DESCRIPTION OF THE DRAWINGS

By way of example only, specific embodiments will be described more fully hereinafter with reference to the accompanying figures, wherein:

FIG. 1a shows a generic AACMM;

FIG. 1b illustrates a prior art measurement routine wherein unnatural gestures are required from an operator;

FIG. 2 depicts schematically an operator action sensor as a four-degrees-of-freedom displacement sensor arranged around one of the links and an orientation dependent force measurement with the said sensor;

FIG. 3 depicts alternative arrangements for operator action sensors;

FIG. 4 depicts by a flowchart an embodiment of the inventive method;

FIG. 5 depicts a servo-torque aided horizontal movement of the probe;

FIG. 6 depicts by a flowchart an embodiment of the assistance functionality;

FIG. 7 depicts two alternative utilizations of the inventive operator action sensor in a measurement task where high accuracy and reach are required;

FIG. 8 depicts by a flowchart a servo-torque aided attitude keeping of the second link;

FIG. 9 depicts schematically a setting of upper and lower safety levels;

FIG. 10 depicts a flowchart the application of safety levels; and

FIG. 11 depicts an exemplary embodiment of a counterweight unit.

### DETAILED DESCRIPTION

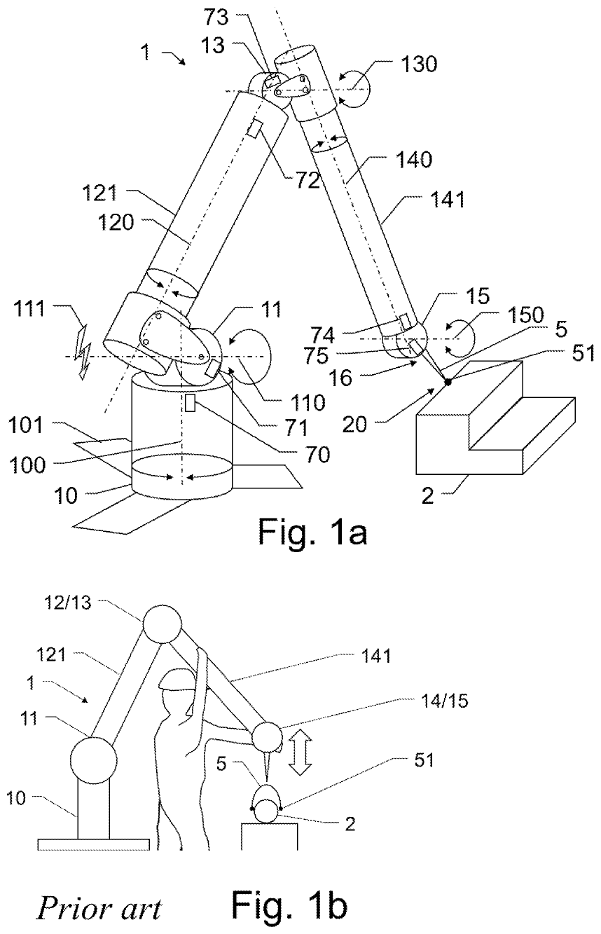

FIG. 1a shows a generic AACMM 1 performing a coordinate measurement on a workpiece 2. The depicted AACMM is equipped with a tactile sensor as the probe 5 mounted on the probe interface 16, i.e., the operator performs the coordinate measurement by touching the object point 20 with the tactile sensing element 51, depicted as ruby sphere. The AACMM 1 comprises a base 10 with fixing elements 101, e.g., permanent magnets, screws, pneumatic components etc., configured to provide mechanical coupling with the environment in a fixed pose relative to the workpiece. The AACMM 1 also comprises a set of articulated members 11-15,121,141 connecting the probe 5 to the base 10. The articulated members 11-15,121,141 comprise links 121,141 and joints 11-15.

In the depicted embodiment each of the joints 11-15 and the base 10 provides one rotational degree of freedom about the respective axes 100,110,120,130,140,150. The links 121,141 are elongated cylinders and the axes of rotation 120,140 of the segment joints 12,14 correspond to the direction of elongation. The further joints 11,13,15 are depicted as hinges providing a rotation about an axis perpendicular to the axes 100,120,140 of the base 10 and/or of the links 121,141. The proximal side of the joints 11-15 has a fixed spatial relationship with the respective proximal component. The AACMM 1 comprises a set of internal sensors 70-75. Each sensor is associated with at least one of the members 11-15,121,141 or the base 10 and provides actual joint and/or actual link data. In the depicted embodiment the first joint 11 is motorized 111, i.e., the AACMM 1 is configured to provide a servo-torque for the first joint 11 in response of operator actions. While many features are illustrated with embodiments like the one depicted in FIG. 1, the disclosure is not limited to this embodiment.

FIG. 1b depicts a measurement routine, wherein the diameter of a cylindrical workpiece 2 is determined by an AACMM 1 having a probe 5 with a tactile sensing element 51. The depicted AACMM comprises a set of members 11-15,121,141 connecting the probe 5 to a base 10. For simplicity the depicted links 121,141 are considered as essentially rigid members, while some of the depicted joints 11-15 are considered to provide mobility in more than one degree of freedom. To ensure the highest possible accuracy, the attitude of the members 11-15,121,141 and the probe 5 should be consistent throughout the measurement. This can be achieved using the depicted method, wherein the members 11-15,121,141 and the probe 5 are constrained to a vertical plane, by the operator holding the second link 141, or alternatively the second joint 12/13 and moving the probe 5 vertically. For this, however, the operator either must grip the second link 141 far from the probe, as depicted, or have to exert excessive torque. Both are tiresome. Moreover, they could result in a bending of the second link 141 causing a temporary or permanent loss of accuracy for the AACMM 1.

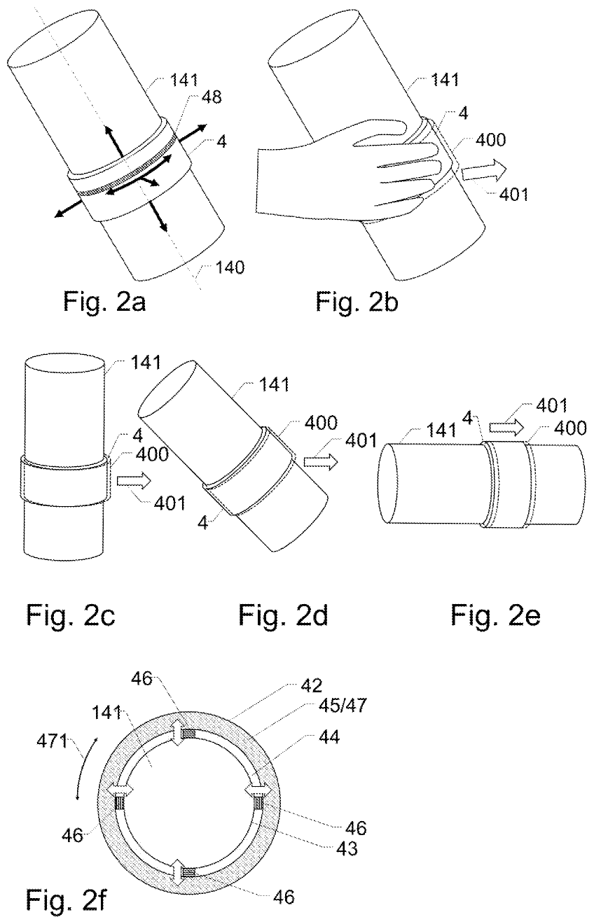

FIG. 2 depicts a first embodiment of the operator action sensor 4 as a touch sensitive band mounted to the hand-controlled member. The depicted hand-controlled member is the second link 141, i.e., a link kinematically close to the probe. The operator action sensor 4 is mounted such that it is concentric to the second link 141 in a rest state. The operator action sensor 4 is elastically displaceable to a displaced state by three translation directions and a rotation around the axis 140 of the second link 141. The measured displacement 400 comprises information regarding a force 401 or torque exerted by the operator.

The depicted operator action sensor 4 is foreseen to (i) provide an operator contact area for the operator to support the second link 141, and (ii) at least partially transfer a driving force 401 exerted to manually guide the second link 141 to a new pose. The depicted operator action sensor 4 comprises a feedback element 48, depicted as a light emitting band, the light emitting band is configured to provide a feedback regarding the status of the AACMM and/or the operator action sensor 4, e.g., whether the system is ready for operation or an error has been detected and/or certain modes are active. The skilled person might provide alternative visual, acoustic, or haptic feedback elements 48. The operator action sensor 4 might comprise or act as touch sensitive surface configured to receive operator command input data, e.g., regarding the activation of certain modes of the AACMM. The operator command input data might correspond to a touch gesture, e.g., a multi-touch action and/or a grip gesture.

FIG. 2c-e depicts the measurement of the force 401 exerted by the operator for vertical (2c), angled (2d), and horizontal (2e) orientation of the second link 141 and the operator action sensor 4. Depending on the orientation the displacement 400 might correspond to different relative movements, i.e., different degree of freedom of the operator action sensor 4. It is advantageous to utilize operator action sensors with at least three degrees of freedom, particularly when the displacement 400 to force 401 response is isotropic and/or calibrated.

FIG. 2f depicts a cross-sectional view of the operator action sensor mounted to the second link 141 as hand-controlled member. The operator action sensor comprises an outer surface 42 configured to be held by the operator, an inner surface 43 configured to interact with the second link, in particular to transfer a part of the force or torque exerted by the operator, an internal volume 44 comprising a sensing element 46, depicted as two pairs of uniaxial piezo elements, configured to provide the operator action sensor data. The operator action sensor further comprises a thermal isolation region 45 configured to provide a thermal isolation between the inner 43 and the outer surfaces 42. In the depicted embodiment the thermal isolation region 45 is also configured to act as a bearing 47 configured to provide a rotatability 471 of the outer surface 42 with respect to the internal volume 44 such that the operator action sensor data is provided independently of the rotation state of the outer surface 42. In alternative embodiments, the rotation state of the outer surface 42 and/or a torque applied to rotate the outer surface 42 about the second link 141 might be comprised by the operator action data.

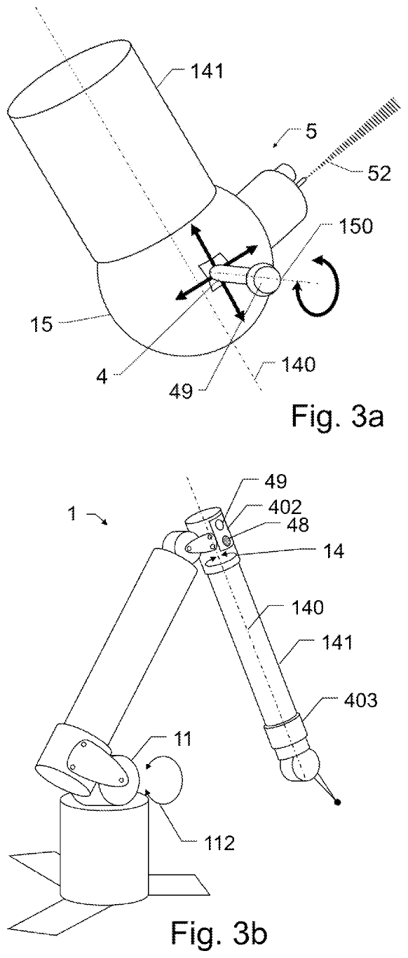

FIG. 3a depicts a second embodiment of the operator action sensor 4 as a joystick providing two translational and one rotational degree of freedom (about the axis 150 of the third joint 15). Alternatively or additionally, the joystick might also provide a third translational degree of freedom or a rotational degree of freedom about the axis 140 of the second link 141. The joystick is mounted on the third joint 15, as the hand-controlled member, along the axis of rotation 150. The joystick also comprises a button as command input element 49 configured to receive operator command input data, e.g., regarding the activation of certain modes of the AACMM. The joystick might comprise further command input elements. The depicted joystick is also foreseen to provide the functions mentioned in the previous embodiment. The probe 5 in the depicted embodiment is a non-contact probe emitting a probing radiation 52, e.g., a structured light.

FIG. 3b depicts a third embodiment of the operator action sensor comprising a first 402 and a second sensor element 403. The second sensor element is mounted to a second link 141 as a hand-controlled member, while the first sensor element 402 is mounted to the second segment joint 14. Said joint provides a rotatability to the second link 141 about the second segment axis 140. The second segment joint 14 is coaxial with the second link 141. Such arrangements are beneficial when the operator wishes to set the pose of the second segment axis 140 with high precision and performs a two-hand grip by the first 402 and second sensor elements 403. This can be utilized e.g., in setting a forbidden zone to the AACMM 1. The first sensor element 402 also exhibits a command input element 49, depicted as a button, and a feedback element 48, depicted as an LED light. The operator could press the button to record a rotation state 112 of the first joint 11 representing a safety limit, wherein the feedback element 48 provides feedback regarding a recording of the safety limit. Alternatively or additionally, a desired attitude of the second segment axis can also be recorded. The feedback element 48 might indicate whether the assistance functionality is active.

The depicted embodiments of the operation action sensor serve only illustrative purposes, the invention is not limited to the depicted embodiments. The skilled person could provide a combination of the depicted features or alternative embodiments realizing the features of the inventive AACMM and the method.

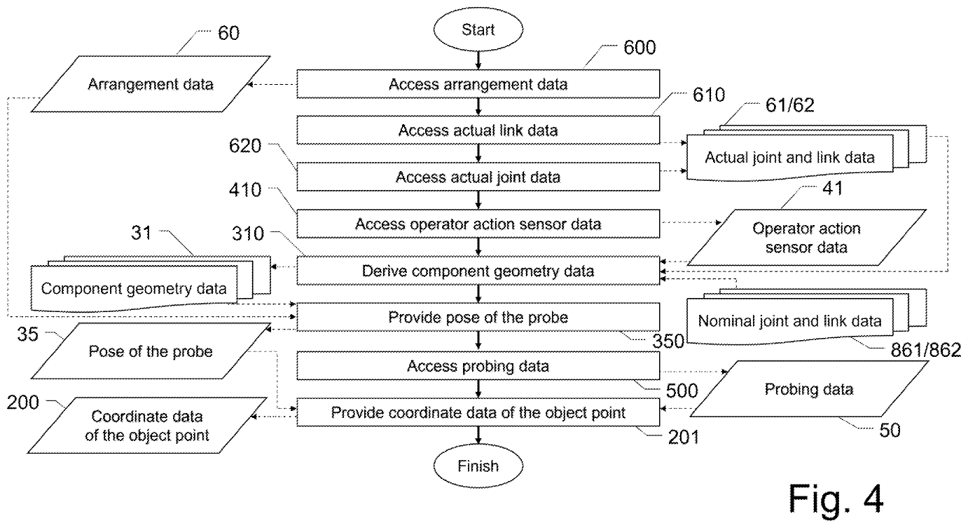

FIG. 4 depicts a flowchart regarding the functioning of an inventive computer implemented method. Flow/command lines are shown with bold while data lines are shown with dashed lines. Some flow- and/or data lines might not be shown in the schematic flowchart for transparency reasons. While the execution of some steps depends on the availability of certain data, reasonable variations in the sequence of the steps are possible within the sense.

In the first step arrangement data 60 of the components of the AACMM are provided 600. Arrangement data 60 might be in the form of a kinematic chain or dynamic modelling of the AACMM. In the next step actual link data 61 and actual joint data 62 regarding are accessed 610/620 from internal sensors associated with the respective links and joints. This is followed by accessing 410 operator action sensor data 41. The operator action sensor data 41 comprise data regarding (a) the force exerted and/or the torque by the operator on the hand-controlled member, and/or (b) the displacement caused by the operator action. Based on the actual joint 61 and link data 62, nominal joint 861 and link data 862 and the operator action sensor data 41 the component geometry data 31 is derived 310. Derivation 310 in the sense might be modelling based on the mentioned data and the arrangement data 60. Alternatively, the component geometry data 31 might be provided by associating the actual joint 61 and link data 62, and the nominal joint 861 and link data 862 to the respective components. The pose 35 of the probe is provided 350 based on the component geometry 31 and arrangement data 60. Coordinates 200 of the object point are provided 201 based on the pose 35 of the probe and the accessed 500 probing data 50.

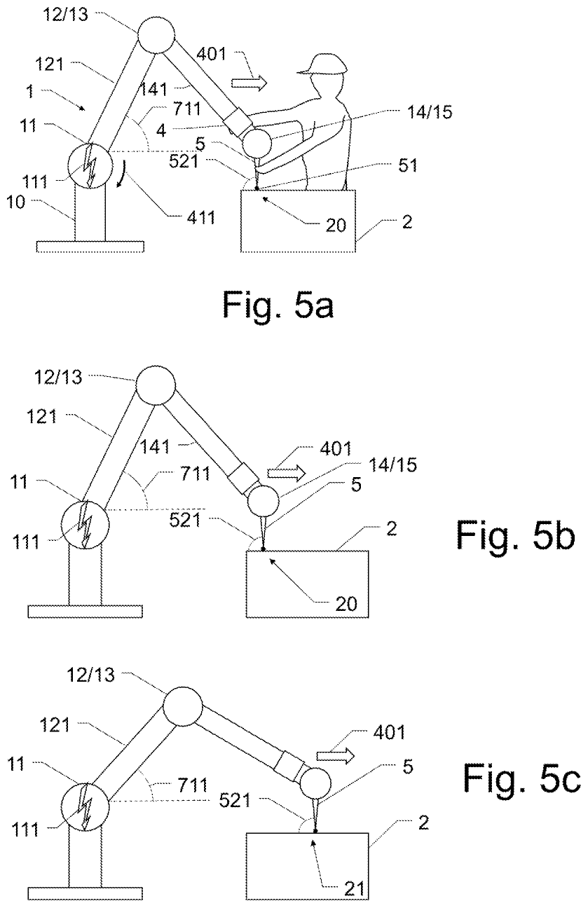

FIG. 5a depicts a measurement of workpiece 2 with an inventive method using an inventive AACMM 1. The AACMM comprises a set of members 11-15,121,141 connecting the probe 5 to a base 10. In the depicted embodiment the probe 5 is a tactile probe comprising the tactile sensing element 51, depicted as ruby sphere. The tactile sensing element 51 establishes a contact with an object point 20 on the workpiece 2 and provides probing data regarding the object point 20. To ensure the highest precision it is recommended that the angle 521 between the probe 5 and the surface of the workpiece 2 at the object point kept in certain range, e.g., the probe 5 is substantially perpendicular to the surface of the workpiece 2.

The AACMM 1 further comprises an operator action sensor 4 mounted on a hand-controlled member, depicted as the second link 141, and configured to measure operator action sensor data. The operator action sensor data comprises data regarding a force 401 exerted by the operator, said force is representative of a planned operator action. The AACMM also comprises a motorized counterweight unit 111 associated with the first joint 11. The motorized counterweight unit 111 is configured to set a rotation state of the first joint, respectively the angle 711 of the first link 121 to a horizon, to target value by applying a servo-torque. Moreover, the motorized counterweight unit 111 is configured to provide a servo-torque responsive to force 401 exerted by the operator. The servo-torque might act in a direction corresponding to a resultant torque 411 for a first joint 11 arising from the force 401 or torque exerted by the operator. Motorizing the base 10 too, and providing a base servo-torque based on the sensor data from the operator action sensor is especially beneficial as it allow to perform the depicted measurement such that the members 11-15,121,141 are constrained to a vertical plane.

Owing to this arrangement the operator can perform a measurement as depicted in FIG. 5a, i.e., by guiding the probe 5 with one hand, in particular setting the distance and the angle 521 between the probe and a surface of the workpiece 2, while holding operator action sensor 4 mounted on a hand-controlled member kinematically close to the probe 5 with the other hand. The operator thereby controls the rotational state of the first joint 11. Such natural measurement gestures reduce the workload as compared to the prior art system. Moreover, owing to the gesture driven, real-space control by the operator action sensor 4 a control of the attitude of the members 11-15,121,141 is intuitive.

FIG. 5b depicts a first phase of a measurement of the workpiece 2, wherein coordinate data of the object point 20 is determined. FIG. 5c depicts a second phase, wherein coordinate data of a further object point 21 is determined. The operator's intent is to guide the probe 5 in a horizontal plane while maintaining a right angle 521 between the probe 5 and the surface of the workpiece 2. This intent is reflected by the force 401 exerted by the operator on the hand-controlled member. The motorized counterweight unit 111 provides the servo-torque based on the force 401 exerted by the operator such that the movement of the probe 5 is constrained to a horizontal plane, and in particular the members 11-15,121,141 are constrained in a vertical plane. This is achieved by adjusting the rotation state of the first joint 11, or in other words, the angle 711 of the axis of the first link 121 to a horizon. The second joint 12/13 is idling to provide the appropriate attitude.

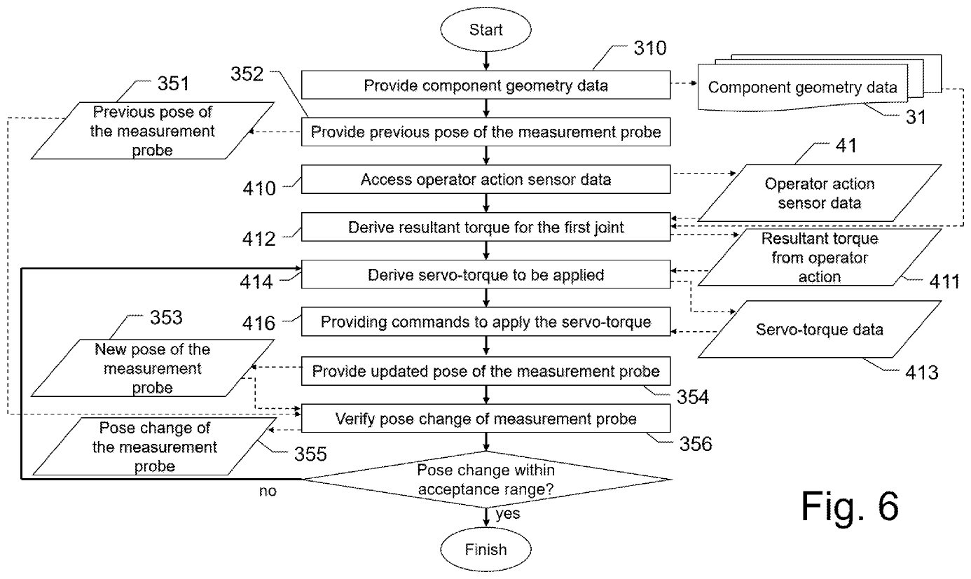

FIG. 6 depicts a flowchart relating to a servo-torque aided measurement shown in FIG. 5. The component geometry data 31, a previous pose 351 of the probe, and the operator action sensor data 41 are provided 310,352,410 e.g., as shown in FIG. 4. The resultant torque 411 from the operator action is derived 412 based on the operator action sensor data 41, the component geometry data 31 and the arrangement data (not shown). In other words, the AACMM is modeled and the effects of the force and/or torque applied by the operator guiding the hand-controlled member are calculated. Based on the resultant torque 411 the servo-torque 413 is derived 414 and applied 416 to the first joint. In the depicted case the servo-torque 413 is provided to aid the desired horizontal movement of the probe. The depicted flowchart comprises control steps to ensure this effect. The said control steps are (i) providing 354 a new pose 353 of the probe, and (ii) verifying 356 the pose change 355. If the pose change 355 is not fulfilling an acceptance criterion the servo-torque 413 is adjusted 414.

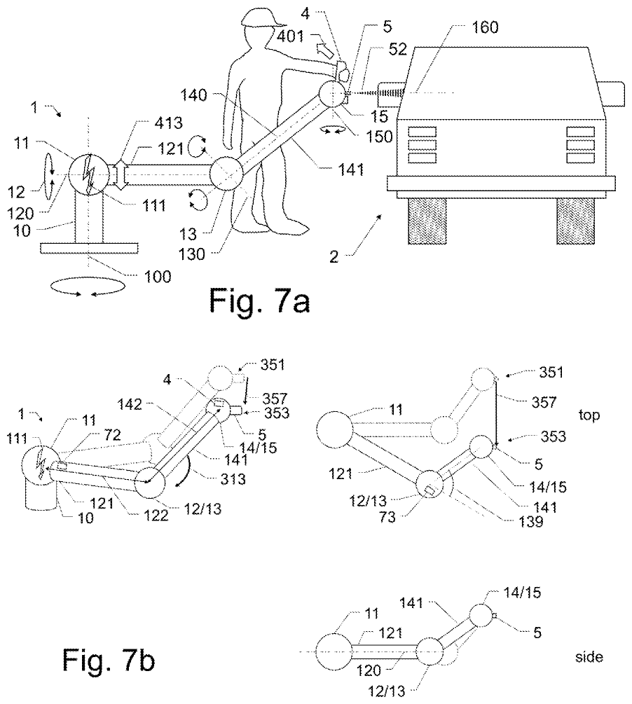

FIGS. 7a-7d show a quality control measurement of a car as large workpiece 2. For measuring similar workpieces both high reach and accuracy are required from the AACMM 1. Short measurement times often form a third requirement, which necessitates a parallelized measurement by a non-contact probe 5 emitting a probing radiation 52. Thus, the pose of the probe 5 is not constrained by a mechanical contact with the object points. Since measuring a deviation from a vertical or horizontal orientation can be executed more precisely it is advantageous to constrain at least one member to such orientations. The base 10 is vertical and enables a horizontal rotation about its axis 100. In the embodiment depicted in FIG. 7a the motor 111 of the first joint 11 provides a servo-torque 413 such that the axis 120 of the first segment joint 12, and respectively the first link 121, is horizontal. The second joint 13 is idling and an orientation of its axis 130 is constrained by attitude of the first 121 and second links 141. The operator guides the probe 5 such that its axis 160 is horizontal using a handle mounted on the third joint 15, i.e., utilizing a “one-handed grip”. The respective axes 140,150 are aligned by this manual guidance. The third joint 15 is the hand-controlled member in the sense. The handle is an operator action sensor 4 providing operator action sensor data regarding the torque and force 401 exerted by the operator. Said operator action sensor data is utilized to derive component geometry data and with that the pose of the probe 5. As the horizontal pose of the axis 120 of the first segment joint 12 can be provided irrespectively of the operator action, the operator sensor data is not utilized to control the servo-torque 413. It might be processed to provide an overload warning and/or to determine whether the force 401 exerted by an operator is indicative of an intended termination of the measurement phase, e.g., a command provided by force override.

FIG. 7b depicts in three views a schematic movement 357 of the probe 5 from a previous pose 351 to a new pose 353 and the related behavior of the base 10 and the members 11-15,121,141 during a measurement step shown in FIG. 7a. The operator guides the probe 5 with a horizontal movement 357. The path of the probe and the pose of the respective joint 15 is directly provided by the operator action. Respective sensors 72,73 provide measured lengths 122,142 of the links 121,141 and the pose changes, only one exemplary pose change 139 is shown, provided by the joints 11-15. To maximize the reach provided by the first link 121, the first link 121 and the axis 120 of the first segment joint 12 is constrained to a horizontal movement 313 by the motorized 111 first joint. As the AACMM 1 represents an under-determined system, the idling joints, here the joints 12-14, provide the necessary mobility under these conditions. The operator action sensor 4 does not directly contribute to the control of the motorized 111 joint 11, however it might provide data on whether the operator applies excessive force which might lead to temporary or permanent loss of accuracy and/or an override signal indicating that the operator wishes to end the constrained motion of the first link 121.

FIG. 7c depicts an alternative measurement with the AACMM 1, wherein the axis 140 of the second link 141 and with that the second segment joint 14 is constrained to a horizontal plane. The operator exerts force 401 on the band, acting as operator action sensor 4, mounted on the second link 141. The handle during such measurement is only utilized to provide the attitude of the probe 5, thus it is operated without exerting substantial force. Based on the operator action sensor data the motor 111 provides the servo-torque to set an angle of the first joint 11 to keep the axis 140 of the second link 141 horizontal. The base 10 and the second joint 13 are idling and constrained by attitude of the first 121 and second links 141.

FIG. 7d depicts in three views a schematic movement 357 of the probe 5 from a previous pose 351 to a new pose 353 and the related behavior of the base 10 and of the members 11-15,121,141 during a measurement action shown in FIG. 7c. For illustration purposes the movement 357 of the probe 5 corresponds to the same movement as depicted in FIG. 7b. Aspects can be applied with different probe movements 357, in particular the height of the probe might change as a result of the movement 357. The operator action sensor 4 might provide operator action sensor data regarding such desired height changes.

The constraint of the measurement, i.e., that the axis 140 of the second link 141 is horizontal, might be provided based on modelling the AACMM 1 taking into account the operator action sensor data. Additionally or alternatively, the AACMM 1 might comprise a levelling sensor 741 associated with the second link 141. Said levelling sensor 741 might be integrated to the internal sensors or the operator action sensor 4. The motor 111 associated with the first joint 11 sets the servo-torque to set the angle 711 of the axis 120 of the first link 121 to the horizontal, e.g., based on a pose change 119 data measured by the respective sensor 71. FIGS. 7b and 7d also illustrates the underdetermined nature of the AACMM 1, i.e., that the same poses 351,353 of the probe 5 could be realized by different poses of the members 11-15,121,141. Unlike to the case depicted in FIG. 7b, keeping the axis 140 of the second link 141 horizontal requires an active processing of the pose 351,353 of the probe 5 and the operator action sensor data.

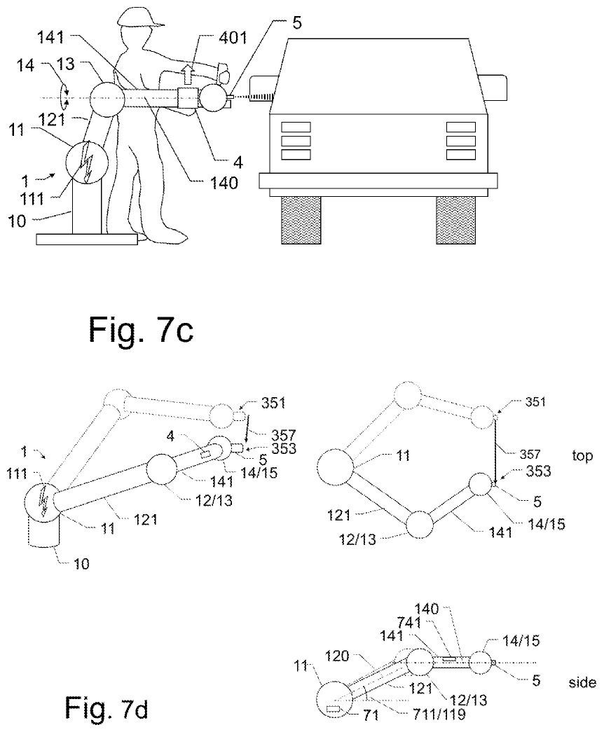

FIG. 8 depicts a flowchart relating to a measurement aided by the assistance functionality 81, i.e. applying a servo-torque 413 based on a derivation 349 of an intended movement 341. For that the system determines 340 the pose 34, in particular the attitude of, of the operator action sensor. The depicted method is based on accessing 600 arrangement data 60 and determining 310 component geometry data 31 based on accessed 610/620 actual link 61 and joint data 62 as well as accessed 410 operator action data 41. The considerations regarding the pose determination of the probe, as shown in FIG. 4, could be applied accordingly to this case.

If the pose 34 of the operator action sensor as well as the operator action sensor data 41 is known, an intended movement 341 with respect to an external reference system and/or reference system of the motorized joints, in particular the first joint, could be derived 349. The servo-torque 413 can be applied 414 based on the intended movement 341 to reduce the force exerted by the operator and/or, to provide the pose of a given member. While the depicted complete modeling of the AACMM is advantageous for accuracy and reproducibility of the poses these steps are not strictly necessary for the assistance functionality 81. Alternatively or additionally, the operator action sensor might be provided with a leveling sensor and the operator action sensor data 41 is interpreted on the basis of the data from the leveling sensor. The depicted assistance functionality 81 can be advantageously extended to provide further functionalities by providing a preferred attitude, height for one or more of the members or by providing one or more features from the examples of FIGS. 4-7.

It is clear that the examples depicted in FIGS. 5-8 are illustrations of the concept and not an express limitation. The disclosure is equally applicable when the movement of other articulated members are constrained, or when the movement is completely free. Constrained movement in the sense might equally cover exact constraints (i.e, wherein one or more degrees of freedom are locked) and substantial constraints (i.e. the counterweight unit attempts to provide a preferred range). The AACMM might comprise additionally or alternatively further counterweight unit associated with members other than the first joint and/or with the base. To perform the methods illustrated by FIGS. 5-8 a counterweight unit, in particular a motorized counterweight unit is necessary, other aspects are applicable without such counterweight unit.

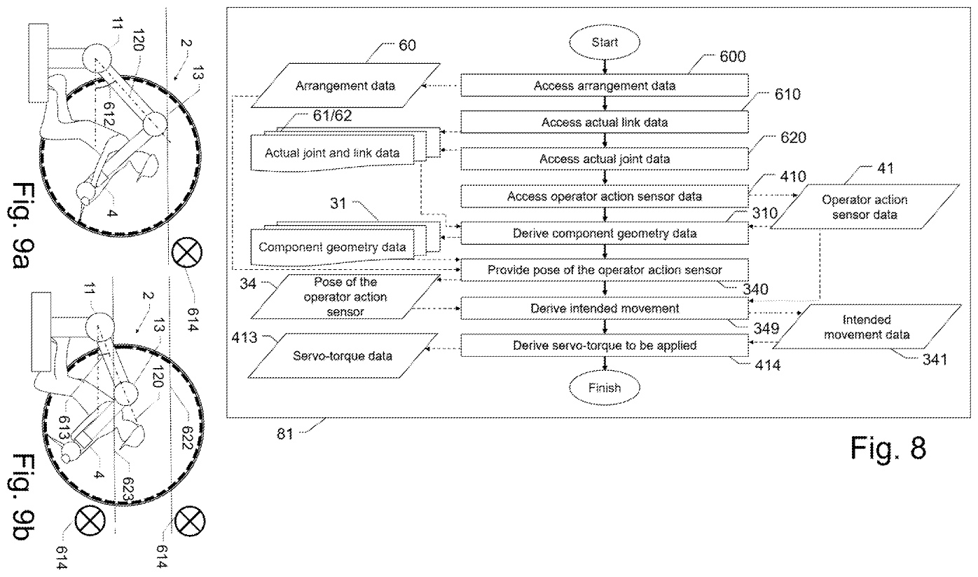

FIG. 9 depicts the setting of a forbidden zone 614 to the first joint 11 for a measurement of a workpiece 2 with limited clearance, e.g. measuring inside a tube. The operator first sets an upper safety level 612, as shown in FIG. 9a. This can be achieved by gesture control of the operator action sensor 4, e.g., by keeping the operator action sensor 4 in a fixed position. While not mandatory this can be beneficially combinable with motorized first joints 11 and operator action sensors 4 having a plurality of sensor elements, as shown in FIG. 3b. When the upper safety level 612 is registered the operator sets a lower safety level 613 similarly. Depending on the measurement task it is possible that only a single safety level 612,613 is set. The safety levels 612,613 on the one hand represent allowed rotation states of the first joint 11, or an allowed attitude range of the first segment axis 120. On the other hand, they represent an allowable height limit 622,623 of the second joint 13.

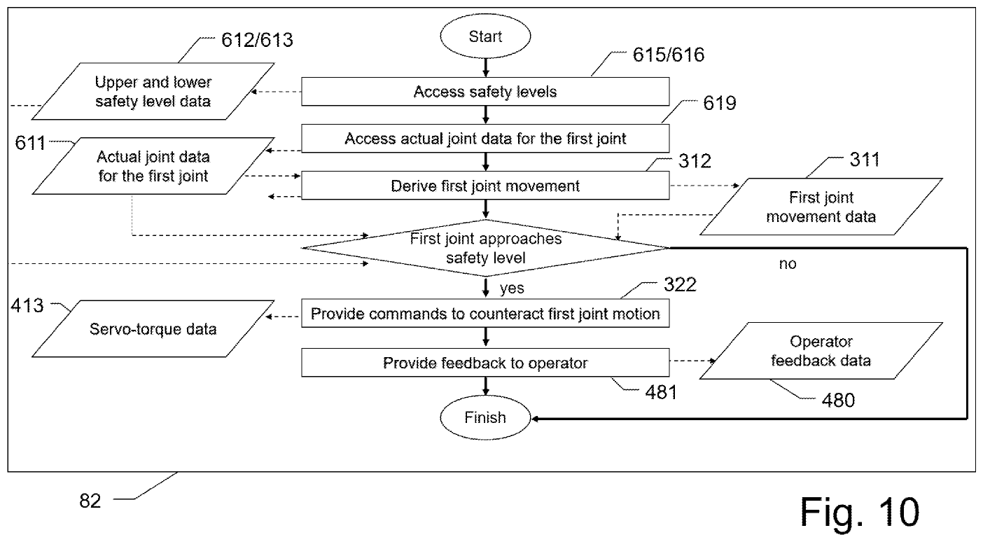

FIG. 10 depicts a flowchart relating to the safety functionality 82. In the first step the safety functionality 82 accesses 615/616 the respective upper 612 and lower safety levels 613. The safety functionality then accesses 619 the actual joint data 611 for the first joint. Based on the current and historic joint data the safety functionality 82 derives 312 the movement 311 of the first joint. Based on the actual joint data 611 and the movement data 311 the safety functionality 82 assesses whether the first joint approaches one of the safety levels 612/613. When the first joint approaches the safety levels, commands are provided 322 to counteract the detected movement 311. In the depicted embodiment it is performed by adjusting the servo-torque 413, i.e., the safety functionality 82 is provided by the assistance functionality. Alternative embodiments are also possible, in particular a brake might be activated. Additionally, a feedback 480, in e.g., a visual or audio warning, is provided 481 to the operator. Embodiments of the safety functionality 82 without providing a servo-torque 413 are also possible. Indeed, such embodiments are especially suitable for non-motorized AACMMs and can also be realized by the inventive system and method.

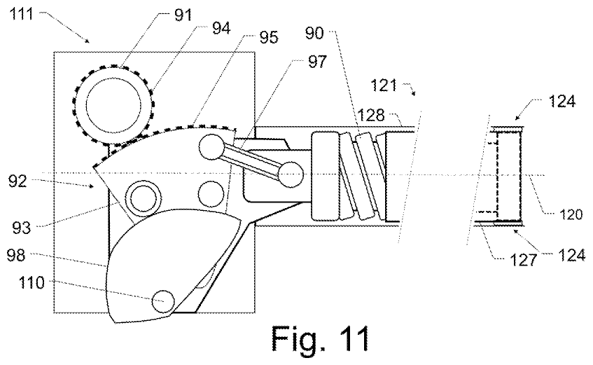

FIG. 11 illustrates an embodiment of the counterweight unit 111 comprising a spring as passive component 90 and a motor, represented by a gearbox, as active component 91. The spring is arranged along the axis 120 of the first link. A mechanism 92 comprising a lever gear 93 configured interact with the active component 91 via corresponding gears 94/95. The passive component 90 is interacting with the level gear 93 via a rod 97. The mechanism comprises a cam 98 mounted to the axis 110 of the first joint. The mechanism 92 thereby transfers torques provided by the active 91 and passive components 90 to the first joint 11. The depicted first link 121 comprises the first link shell 128 and the internal support 127. The interaction of the first link shell 128 and internal support 127 takes place only in an interaction area 124. Many alternatives of the depicted counterweight unit 111 exist. A non-exclusive list comprises a passive component 90 with a leaf or torsion spring, a cam follower instead of the depicted lever gear 93, an active component 91 mounted directly to the axis 111 of the first joint. These and further similar options are within the sense.

Although aspects are illustrated above, partly with reference to some specific embodiments, it must be understood that numerous modifications and combinations of different features of the embodiments can be made. All of these modifications lie within the scope of the appended claims.

1. An operator action sensor for an articulated arm coordinate measuring machine, configured:
to be mounted on a hand-controlled member of the articulated arm coordinate measuring machine, the hand-controlled member being configured to be held by an operator of the articulated arm coordinate measuring machine;
to detect an operator action, the operator action comprising exertion of a force and/or a torque by the operator to the operator action sensor for providing a desired pose of the hand-controlled member;
to generate operator action sensor data wherein the operator action sensor data comprises data regarding:
the force and/or torque exerted by the operator in at least two degrees-of-freedom, and/or
a displacement caused by the operator action in at least two degrees-of-freedom; and
to provide the operator action sensor data to the articulated arm coordinate measuring machine.

2. The operator action sensor according to claim 1, comprising a feedback element configured to provide feedback regarding an operational status of the operator action sensor and/or the coordinate measuring machine.

3. The operator action sensor according to claim 1, comprising a command input element configured to receive operator command input data and to provide the operator command input data to the coordinate measuring machine,
wherein the command input element comprises:
a hardware button or switch and the operator command input data correspond to an interaction with or a state of the button or switch,
a touch sensitive surface and the operator command input data correspond to a touch gesture or a multi-touch gesture.

4. The operator action sensor according to claim 1, comprising:
an outer surface configured to be held by the operator,
an inner surface configured to interact with the hand-controlled member,
an internal volume comprising a sensing element configured to provide the operator action sensor data, and
a thermal isolation region configured to provide a thermal isolation between the inner and the outer surfaces, and
a bearing configured to provide a rotatability to the outer surface with respect to the internal volume such that the operator action sensor data is provided independently of the rotation state of the outer surface.

5. An articulated arm coordinate measuring machine comprising a set of internal sensors, a probe for approaching an object point, a set of members connecting the probe to a base, the members comprising links and joints, wherein:
the probe is configured to be moved at least partially manually by an operator guiding a hand-controlled member of the set of members,
each sensor of the set of internal sensors is:
associated with at least one of the members or the base, and
configured to provide actual link data regarding a measured length and/or bending of the respective link, and/or actual joint data regarding a measured pose change provided by the respective joint or the base,
the probe is configured to measure probing data corresponding to an interaction between the probe and the object point, and
the coordinate measuring machine is configured:
to provide a pose of the probe based on the actual link and the actual joint data,
to provide coordinate data of the object point based on the probing data and the pose of the probe,
wherein the coordinate measuring machine comprises an operator action sensor according to claim 1 mounted at the hand-controlled member.

6. The coordinate measuring machine according to claim 5, comprising a pose determination functionality for determining the pose of the probe, wherein the pose determination functionality comprises:
accessing arrangement data comprising data regarding an arrangement of the members and kinematic constraints between the members,
providing component geometry data comprising:
for each of the links
the actual link data, and/or
link model data regarding a calculated length and/or bending of the respective link based on the arrangement data, the actual link data, the actual joint data, and the operator action sensor data, and
for each of the joints
the actual joint data, and/or
joint model data regarding a calculated pose change provided by the respective joint based on the arrangement data, the actual link data, the actual joint data, and the operator action sensor data,
providing the pose of the probe based on the arrangement data and the component geometry data.

7. The coordinate measuring machine according to claim 5, comprising:
a counterweight unit associated with a first joint and configured to provide a servo-torque,
an assistance functionality comprising:
deriving for the first joint a resultant torque resulting from the force or torque exerted by the operator,
providing a servo-torque acting in a direction corresponding to the resultant torque,
wherein the coordinate measuring machine:
regulates the servo-torque such that the force and/or the torque exerted by the operator or the displacement caused by the operator is reduced or approaches zero,
derives the resultant torque based on the arrangement data, the actual joint data and the actual link data.

8. The coordinate measuring machine according to claim 7, wherein:
the first joint connects a base to a first link,
the counterweight unit comprises:
a passive component comprising a spring or a coil spring arranged along an axis of the first link,
an active component comprising a motor, and
a mechanism configured to transfer torques provided by the active and passive components to the first joint,
the torque provided by the passive component is constant or corresponds to a gravity related torque acting on the first joint, and
the torque provided by the active component is responsive to the operator action sensor data.

9. The coordinate measuring machine according to claim 7, being configured to provide the servo-torque in dependence of:
a pose and type of the probe, and/or
a linear and/or angular velocity of the probe, and/or
an orientation of the second link, and/or
a pose of the second joint, and/or
a previous operator action or operator command input data,
wherein:
the coordinate measuring machine is configured to operate in a precision mode and in in a repositioning mode,
the precision mode and the repositioning mode are activated automatically based on the pose of the probe, automatically based on the operator action data, or manually based on receiving respective operator command input data,
wherein in the precision mode:
a responsiveness of the active component to the operator action sensor data is increased to a value corresponding to the precision mode, and
a velocity of at least one member is limited to a velocity range corresponding to a precision mode and/or,
an orientation of at least one member is limited to an orientation range corresponding to the precision mode,
wherein in the repositioning mode:
velocities above the velocity limit of the precision mode are enabled,
the responsiveness of the active component to the operator action sensor data is decreased to a value corresponding to the repositioning mode.

10. The coordinate measuring machine according to claim 5, wherein the hand-controlled member is a link kinematically nearest to the probe.

11. A method for determining a force or a torque exerted by an operator guiding a hand-controlled member of an articulated arm coordinate measuring machine in an external reference frame,
wherein the coordinate measuring machine comprises a probe for approaching the object point, and a set of members connecting the probe to a base, the members comprising links and joints,
wherein the method comprises:
accessing arrangement data comprising data regarding an arrangement of the members and kinematic constraints between the members;
accessing component geometry data comprising:
for each of the links:
actual link data regarding a measured length and/or bending of the respective link, and/or
link model data regarding a calculated length and/or bending of the respective link, and
for each of the joints:
actual joint data regarding a measured pose change provided by the respective joint or the base, and/or
joint model data regarding a calculated pose change provided by the respective joint or the base; and
providing the pose of the hand-controlled member based on the arrangement data and the component geometry data,
measuring operator action sensor data, wherein the operator action sensor data comprises data regarding:
the force and/or a torque exerted by the operator on the hand-controlled member, and/or
a displacement caused by the operator action,
deriving the force or torque exerted by the operator guiding the hand-controlled member in the external reference frame based on the pose of the hand-controlled member and the operator action sensor data.

12. The method according to claim 11, further comprising:
providing an overload feedback based the operator action sensor data, and/or deriving intended operator movement data based the operator action sensor data.

13. The method according to claim 11, further comprising:
determining, based on the operator action sensor data, whether the operator acts on the hand-controlled member,
causing a motionless parking state of the coordinate measuring machine, if the operator is not acting on the hand-controlled member, bringing the probe to a pre-defined parking pose.

14. The method according to claim 11, further comprising an assistance functionality, wherein the assistance functionality comprises:
deriving a resultant torque for a first joint resulting from the operator guiding the hand-controlled member, and
applying a servo-torque to the first joint acting in a direction corresponding to the resultant torque.

15. The method according to claim 14, wherein the servo-torque is adjusted to constrain:
a movement of a second joint in a plane perpendicular to the gravity vector, wherein the second joint connects a second link to the first link, or
an orientation of the second link in plane perpendicular to the gravity vector, each of the members to a vertical plane.

16. The method according to claim 11, comprising a safety functionality, wherein the safety functionality comprises:
providing a forbidden zone,
providing an assessment on an approach of the first joint, to the forbidden zone, and
preventing the first joint to enter the forbidden zone.
